(19) United States
(12) Patent Application Publication
(10) Pub. No.: US 2026/0250915 A1
(43) Pub. Date: Aug. 27, 2026

(54) CERAMIC INFILL MATERIALS FOR SYNTHETIC TURF APPLICATIONS

(71) Applicant: CARBO Ceramics, LLC, Houston, TX (US)

(72) Inventors: Brett Allen Wilson, Cypress, TX (US); Zach Powers, Houston, TX (US)

(73) Assignee: CARBO Ceramics, LLC, Houston, TX (US)

(21) Appl. No.: 19/655,506

(22) Filed: Apr. 22, 2026

Related U.S. Application Data
(63) Continuation-in-part of application No. 19/260,029, filed on Jul. 3, 2025.
(60) Provisional application No. 63/726,799, filed on Dec. 2, 2024.

(51) Int. Cl. E01C 13/08; A41G 1/00

(52) U.S. Cl. CPC E01C 13/08; A41G 1/009

(57) ABSTRACT

A synthetic turf system includes a plurality of synthetic turf fibers, and a plurality of ceramic pellets interspersed among the synthetic turf fibers. The ceramic pellets have a hardness on the Mohs scale of 6 to 8, a density of 0.5 to 2.15 g/cm³, and a sphericity and roundness rating of 0.7 to 0.99. The ceramic pellets include a mixture of alumina fines and at least one of kaolin or bauxite. The ceramic pellets are chemically inert and free from respirable quartz silica dust. The ceramic pellets may include a ceramic pellet core and a coating. The coating may be configured to control thermal properties of the ceramic pellets. The synthetic turf system may include small ceramic pellets configured to remain near a surface and large ceramic pellets configured to settle towards a bottom of the system.

### CROSS-REFERENCE TO RELATED APPLICATIONS

The present application claims priority as a Continuation-in-Part of U.S. Provisional application Ser. No. 19/260,029, filed Jul. 3, 2025, which claims priority to U.S. Provisional App. No. 63/726,799, filed Dec. 2, 2024, the disclosures of which are hereby incorporated by reference in their entirety for all purposes.

### TECHNICAL FIELD

The present disclosure relates to synthetic turf systems, and more particularly to a ceramic infill material for synthetic turf.

### BACKGROUND

Synthetic turf systems have gained widespread popularity across various applications, including sports fields, residential landscapes, and commercial spaces. These artificial surfaces offer numerous advantages over natural grass, depending on their application, such as reduced maintenance requirements, consistent playing conditions, and durability in diverse weather conditions. In addition, synthetic turf does not require watering, which makes it a particularly desirable system, especially in areas where water supply is limited.

A critical component of synthetic turf systems is the infill material, which is dispersed between the artificial grass fibers to provide stability, shock absorption, and overall performance enhancement. Traditionally, infill materials have included substances such as crumb rubber, derived from recycled tires, and silica sand. These materials have been widely adopted due to their ability to stabilize turf fibers, provide adequate shock absorption, as well as improve traction and foot stability for users. Additionally, they contribute to extending the useful life of synthetic turf and maintaining surface consistency for optimal game performance.

However, conventional infill materials present several challenges that have prompted the search for alternative solutions. For example, installation of traditional infills can be time-consuming, often requiring extensive compaction, grooming, and leveling processes. This can result in prolonged installation periods, which can result in disruption of facility operations or delaying the availability of playing surfaces.

Another concern with current infill materials is durability. For example, organic and polymer-based infills may degrade over time, which may lead to compaction and reduced resilience. This degradation causes the need for frequent maintenance and eventual replacement, increasing the long-term costs associated with synthetic turf systems.

Yet another concern with current infill materials relates to health and safety. Silica-based infills may release respirable dust particles, which may contribute to respiratory health risks. Furthermore, crumb rubber infill has raised concerns due to the potential presence of hazardous materials that may leach out under high temperatures or through prolonged use.

Still another concern with current infill materials is related to thermal management. Indeed, thermal management is a major challenge faced by many synthetic turf systems. Conventional infill materials, particularly crumb rubber, are known to retain and even amplify surface temperatures. This heat retention can lead to significantly elevated playing surface temperatures, causing discomfort for users and potentially creating dangerous conditions during periods of high ambient temperatures.

Furthermore, environmental concerns are another concern with current infill materials. For example, many current infill materials release microplastics into the water system, particularly when these surfaces are exposed to water through irrigation or rainfall. This issue may be exacerbated by the breakdown of synthetic fibers and polymer infill or polymer coated infill materials over time due to wear and environmental factors. The migration of these microplastics into soil, waterways, and even the food chain has become a growing concern related to the use of current infill materials. Additionally, the long-term ecological impact of these synthetic materials in natural environments is not yet fully understood.

As the demand for synthetic turf continues to grow across various sectors, including sports fields, residential landscapes, and commercial spaces, the above concerns may only grow. The expansion of synthetic turf applications in diverse environments may amplify issues related to installation efficiency, durability, health and safety considerations, thermal management, and environmental impact. Indeed, addressing these challenges may become more urgent as synthetic turf systems are deployed in a wider range of settings and subjected to varying conditions and usage patterns.

### SUMMARY

The present disclosure achieves technical advantages as a ceramic infill material for artificial turf systems. The ceramic infill material of embodiments include functionality that provides significant advantages over traditional infill types.

In particular embodiments, the ceramic infill material of embodiments may be configured for rapid installation. The ceramic infill of embodiments may be installed within a few hours, unlike conventional materials that can require nine or more hours. For example, the ceramic infill of embodiments may include a plurality of ceramic pellets. Due to the uniform size, sphericity, and/or density of the ceramic pellets of the ceramic infill, the ceramic infill may be spread evenly across the turf, reducing installation time to a few hours compared to traditional infill options.

The ceramic infill material of embodiments may be configured for enhanced durability. For example, the ceramic composition of the ceramic pellets of embodiments may provide improved resilience and longevity, maintaining structural integrity longer than organic, polymer-based infill, or sand infill. The ceramic pellets may be configured with high crush and wear resistance, as well as retain structural integrity under heavy use and environmental exposure, reducing the need for frequent replacement and maintenance.

The ceramic infill material of embodiments may be configured to reduce health risks. For example, unlike silica-based infills, the ceramic pellets may be chemically inert and free from respirable silica dust, which may minimize silica dust release. By minimizing silica dust release, the ceramic infill of embodiments minimizes respiratory health risks such as silicosis. This makes the ceramic infill material of embodiments safer for users, particularly in high-activity areas where dust dispersion is more likely, and athletes are likely to be breathing deeply.

The ceramic infill material of embodiments may be configured with thermal regulation functionality. For example, the ceramic infill material of embodiments may be configured with properties that enable the ceramic infill to control or manage the amount of heat retained. In some embodiments, the ceramic infill material of embodiments may be configured to retain less heat, leading to lower surface temperatures of the synthetic turf system. This functionality may improve user comfort and reduce the risk of heat-related injuries. In embodiments, a reduction of up to 50° F. on turf surfaces in direct sunlight may be obtained from the ceramic infill material of embodiments when compared to conventional infill materials, ensuring more comfortable conditions for players and reducing the risk of heat-related injuries.

In embodiments, the ceramic infill may be manufactured from a mixture of a kaolin and alumina fines or bauxite, with optional sintering aids like iron oxide or zinc oxide to enhance its strength. In this manner, the ceramic infill may be configured for high performance. In embodiments, the ceramic pellets of the ceramic infill may have a hardness on the Mohs scale of 6 to 8, a bulk density of 0.5 to 2.15 g/cm³, suitable for even distribution and stability in synthetic turf, and a sphericity and roundness rating of between 0.6 to 0.98, which promotes uniform layering and stability on turf surfaces.

In embodiments, the ceramic infill may be chemically inert and free from hazardous materials, specifically configured to contain no quartz silica or crystalline silica locked in a microstructure of other phases that limits release below a threshold amount or an amount of quartz silica less than a threshold amount, which may address health risks associated with silica dust inhalation.

It is an object of the disclosure to provide a synthetic turf system. It is a further object of the disclosure to provide a method of installing a synthetic turf system, and a ceramic pellet for use as infill in a synthetic turf system.

In one particular embodiment, a synthetic turf system is provided. The synthetic turf system includes a plurality of synthetic turf fibers and a plurality of ceramic pellets interspersed among the synthetic turf fibers. In embodiments, each of the ceramic pellets of the plurality of ceramic pellets has a hardness on the Mohs scale within the range of 6 to 8, a density within the range of 0.5 to 2.15 g/cm³, and a sphericity and roundness rating within the range of 0.7 to 0.99.

In another embodiment, a method of installing a synthetic turf system is provided. The method includes obtaining a plurality of ceramic pellets, configuring the plurality of ceramic pellets with one or more characteristics to facilitate application as an infill for synthetic turf, and spreading the plurality of ceramic pellets over at least a portion of a synthetic turf surface.

In yet another embodiment, a ceramic pellet for use as infill in a synthetic turf system is provided. The ceramic pellet includes a ceramic core and a coating applied to the ceramic core. In embodiments, the ceramic pellet is configured to have thermal regulation properties to control a surface temperature of the synthetic turf system.

In still another embodiment, a method of manufacturing a ceramic pellet for use as infill in a synthetic turf system is provided. The method includes producing a plurality of ceramic pellets, and configuring the plurality of ceramic pellets with one or more characteristics to facilitate application as an infill for a synthetic turf.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 shows an exemplary synthetic turf system that includes a ceramic infill configured with capabilities and functionality in accordance with embodiments of the present disclosure.

FIG. 2A shows an example of a synthetic turf system configured to include ceramic pellets having different densities configured with capabilities and functionality in accordance with embodiments of the present disclosure.

FIG. 2B shows an example of a synthetic turf system configured to include different-sized ceramic pellets configured with capabilities and functionality in accordance with embodiments of the present disclosure.

FIG. 2C shows another example of a synthetic turf system configured to include different-sized ceramic pellets configured with capabilities and functionality in accordance with embodiments of the present disclosure.

FIG. 3 shows an exemplary ceramic pellet with a coating for configuring the ceramic pellet with heat regulation functionality in accordance with embodiments of the present disclosure.

FIG. 4A shows an example color configuration of a ceramic pellet configured for heat regulation in accordance with embodiments of the present disclosure.

FIG. 4B shows another example of a color configuration of a ceramic pellet configured for heat regulation in accordance with embodiments of the present disclosure.

FIG. 5A shows an example of a reflectivity configuration of a ceramic pellet configured for heat regulation in accordance with embodiments of the present disclosure.

FIG. 5B shows another example of a reflectivity configuration of a ceramic pellet configured for heat regulation in accordance with embodiments of the present disclosure.

FIG. 6 shows an example of a ceramic pellet configured for infusion of additional material in accordance with embodiments of the present disclosure.

FIG. 7 shows a high-level flow diagram of operations for installing an infill into a synthetic turf system in accordance with embodiments of the present disclosure.

FIG. 8 shows an exemplary flow diagram of operations for manufacturing ceramic pellets for use as infill material for a synthetic turf system in accordance with embodiments of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses, or which render other details difficult to perceive may have been omitted. It should be understood, of course, that this disclosure is not limited to the particular embodiments illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application, has searched the prior art as disclosed in patents and other published documents, i.e., nonpatent literature. Therefore, the issuance of this patent is evidence that: the elements and limitations presented in the claims are enabled by the specification and drawings, the issued claims are directed toward patent-eligible subject matter, and the prior art fails to disclose or teach the claims as a whole, such that the issued claims of this patent are patentable under the applicable laws and rules of this jurisdiction.

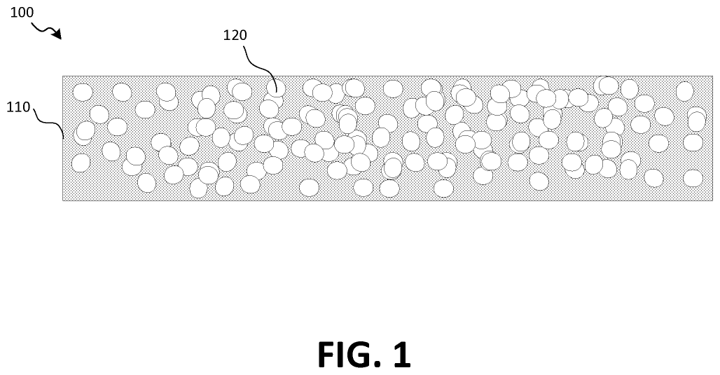

FIG. 1 shows an exemplary synthetic turf system 100 that includes a ceramic infill configured with capabilities and functionality in accordance with embodiments of the present disclosure. As shown in FIG. 1, the synthetic turf system 100 may include synthetic turf fibers 110 and a plurality of ceramic pellets 120. In embodiments, these components of the synthetic turf system 100 may be configured to include various designs and/or configurations for providing functionality as described in embodiments of the present disclosure.

In embodiments, the ceramic pellets 120 may be configured to operate as infill material within the synthetic turf system 100, and the ceramic pellets 120 may be interspersed among the synthetic turf fibers 110. In embodiments, the ceramic pellets 120 may be configured with functionality to improve installation efficiency, enhance durability, promote health safety, provide thermal control, etc. over traditional synthetic turf infill materials. In embodiments, the ceramic pellets 120 may be configured with functionality to control the characteristics or properties of the ceramic pellets 120 to optimize the performance of the ceramic pellets 120 within the synthetic turf system 100, as described herein.

The synthetic turf fibers 110 may operate to simulate the appearance and function of natural grass blades within the synthetic turf system 100. The synthetic turf fibers 110 may be made from synthetic materials such as polyethylene, polypropylene, nylon, etc., and may be durable and resilient, and able to withstand various environmental conditions. In some embodiments, the synthetic turf fibers 110 may be configured with specific characteristics to enhance performance, such as UV resistance to prevent fading and degradation from sun exposure, or antimicrobial properties to inhibit the growth of bacteria and fungi.

In embodiments, the synthetic turf fibers 110 may be arranged in a dense, uniform pattern to create a consistent surface that mimics the look and feel of natural grass. The synthetic turf fibers 110 may vary in length, thickness, and texture depending on the intended application of the synthetic turf system 100. For example, longer or shorter fibers may be configured for sports fields to provide better ball roll and bounce, while shorter fibers may be configured for landscaping applications. In some examples, the synthetic turf fibers 110 may include a mixture of different fiber types or textures to achieve a more natural appearance or to optimize specific performance characteristics.

The ceramic pellets 120 may be configured to operate as infill material within the synthetic turf system 100. In particular, the ceramic pellets 120 may be configured to fill the spaces between the synthetic turf fibers 110, to provide a stable and resilient surface that closely mimics the characteristics of natural grass.

In embodiments, the distribution of ceramic pellets 120 throughout the synthetic turf fibers 110 may play a role in maintaining the structural integrity of the synthetic turf system 100. The ceramic pellets 120 may operate to keep the synthetic turf fibers 110 upright and properly spaced, preventing matting and ensuring consistent playability across the entire surface of the synthetic turf system 100. In some embodiments, the density, size, weight, and arrangement of the ceramic pellets 120 within the synthetic turf fibers 110 may contribute to the stability of the synthetic turf system 100.

In embodiments, the ceramic pellets 120 may be configured with functionality for shock absorption within the synthetic turf system 100. For example, when pressure is applied to the surface, such as during athletic activities or foot traffic, the ceramic pellets 120 may compress and shift slightly, helping to dissipate impact forces. The ceramic pellets 120 may also be configured with drainage functionality. For example, the spaces between the pellets may allow water to percolate through the turf system, preventing pooling on the surface and facilitating quick drying after rain or irrigation. Moreover, the ceramic pellets 120 may be configured with thermal regulation properties to control or manage the heat retention characteristics of the synthetic turf system 100. This may result in a playing surface that remains cooler under direct sunlight than a surface with traditional infill materials.

In embodiments, the ceramic pellets 120 may be composed of a plurality of individual ceramic pellets. The ceramic pellets 120 may include high-performance ceramic media, which may provide enhanced durability and performance characteristics compared to traditional infill materials. In some embodiments, the ceramic pellets 120 may include ceramic pellets that range in sizes and densities. This variation in size and density may allow for customization of the infill material to meet specific operational requirements of different synthetic turf applications.

In embodiments, the size and density of the ceramic pellets 120 may be configured based on the intended application and desired characteristics of the synthetic turf system 100. For example, in some embodiments, smaller, lighter, and less dense ceramic pellets may be used for applications requiring softer surfaces, such as residential landscaping or playgrounds. In some embodiments, larger and denser ceramic pellets may be used for sports fields that require more stability and impact resistance.

In some embodiments, a combination of ceramic pellets 120 with different sizes and densities may be used within the same synthetic turf system 100. These embodiments may allow for optimized performance characteristics, such as improved drainage, enhanced shock absorption, or better thermal regulation. The ability to adjust the size and density distribution of the ceramic pellets 120 may provide a higher degree of flexibility and customization for synthetic turf system 100.

In some embodiments, the ceramic pellets 120 may be configured with varying densities, sizes, and weights to create a layered infill structure within the synthetic turf system 100. In embodiments, given same sized ceramic pellets, ceramic pellets with higher density may settle down and may propagate toward the bottom of the synthetic turf system 100. In embodiments, given ceramic pellets having the same density, smaller pellets may propagate toward and/or to the bottom of the synthetic turf system 100, while larger pellets may remain on top. In still other embodiments, given ceramic pellets having the same density, larger pellets may propagate toward and/or to the bottom of the synthetic turf system 100, while smaller pellets may remain on top.

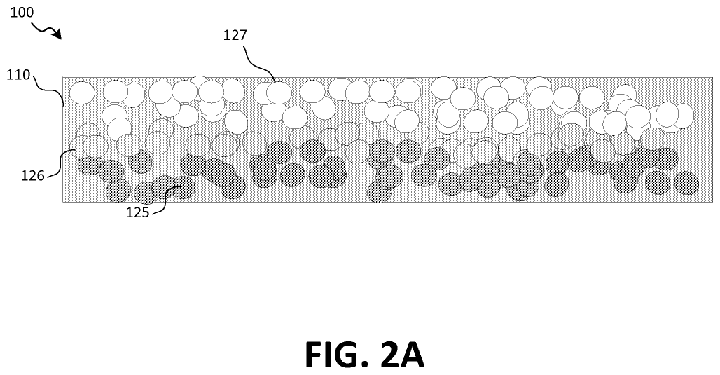

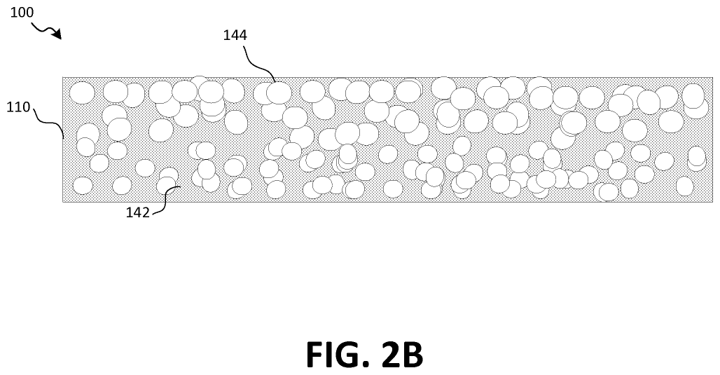

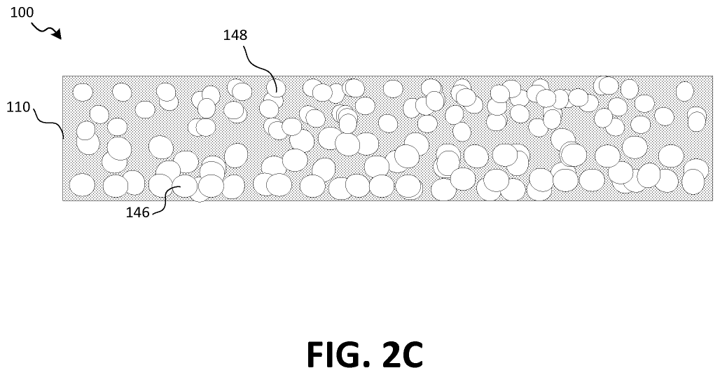

For example, FIG. 2A shows an example of a synthetic turf system configured to include ceramic pellets having different densities configured with capabilities and functionality in accordance with embodiments of the present disclosure. As shown, the synthetic turf system 100 may include ceramic pellets 125, 126, and 127 of the same size. In this example, the ceramic pellets 125, 126, and 127 may have different densities, with the ceramic pellets 125 having a higher density than the ceramic pellets 126, and the ceramic pellets 126 having a higher density than the ceramic pellets 127. Given the same size, the ceramic pellets 125 may be heavier than the ceramic pellets 126, and the ceramic pellets 126 may be heavier than the ceramic pellets 125.

In embodiments, the ceramic pellets 127 may tend to remain near the surface of the synthetic turf system 100, above the ceramic pellets 126. By remaining near the surface of the synthetic turf system 100, the ceramic pellets 127 positioned in the upper layers may interact more directly with environmental factors to which the synthetic turf system 100 may be exposed (e.g., such as water and sunlight). In some cases, the ceramic pellets 127 positioned in the upper layer may absorb water from rain, irrigation, ambient moisture, etc. This water absorption functionality may operate to contribute to an evaporative cooling effect within the synthetic turf system 100. As the absorbed water evaporates from the ceramic pellets 127, this may help reduce surface temperatures, and may enhance the thermal comfort of the playing surface.

In embodiments, the ceramic pellets 125, having a higher density and/or heavier weight than the ceramic pellets 126 and 127, may be used in the lower layers of the infill of the synthetic turf system 100. The ceramic pellets 125 may naturally settle or transition towards the bottom of the synthetic turf system 100. The ceramic pellets 27 in the lower layers may provide functionality that may contribute to the stability of the synthetic turf system 100. The weight and density of the ceramic pellets 127 may help anchor the synthetic turf fibers 110 and may provide a solid foundation for the playing surface.

In embodiments, the ceramic pellets 126, having a higher density and/or heavier weight than the ceramic pellets 127 and a lower density and/or lighter weight than the ceramic pellets 125, may be used in the middle layers of the infill of the synthetic turf system 100. It is noted that in some embodiments, less or more than three different densities and/or weights may be used for the ceramic pellets, and the examples disclosed herein with respect to three densities and weights should not be construed as limiting in any way. Indeed, in some examples, a single weight and/or density may be used, two different densities and/or weights may be used, and more than two different densities and/or weights may be used.

In another example, different sized pellets may be used. For example, FIG. 2B shows an example of a synthetic turf system configured to include different-sized ceramic pellets configured with capabilities and functionality in accordance with embodiments of the present disclosure. As shown, the synthetic turf system 100 may include small ceramic pellets 142 and large ceramic pellets 144. In this example, the small ceramic pellets 142 and the large ceramic pellets 144 may have the same density.

In this example, given the same density, the large ceramic pellets 144 may tend to remain near the surface of the synthetic turf system 100. By remaining near the surface of the synthetic turf system 100, the large ceramic pellets 144 positioned in the upper layers may interact more directly with environmental factors to which the synthetic turf system 100 may be exposed (e.g., such as water and sunlight). In some cases, the large ceramic pellets 144 disposed in the upper layer may absorb water from rain, irrigation, ambient moisture, etc. This water absorption functionality may operate to contribute to an evaporative cooling effect within the synthetic turf system 100. As the absorbed water evaporates from the large ceramic pellets 144, this may help reduce surface temperatures, and may enhance the thermal comfort of the playing surface.

In embodiments, the small ceramic pellets 142 may be used in the lower layers of the infill of the synthetic turf system 100. The small ceramic pellets 142 may naturally settle or transition towards the bottom of the synthetic turf system 100. The small ceramic pellets 142 in the lower layers may provide functionality that may contribute to the stability of the synthetic turf system 100, such as anchoring the synthetic turf fibers 110 to provide a solid foundation for the playing surface.

In still another example, FIG. 2C shows another example of a synthetic turf system configured to include different-sized ceramic pellets configured with capabilities and functionality in accordance with embodiments of the present disclosure. As shown, the synthetic turf system 100 may include small ceramic pellets 148 and large ceramic pellets 146. In embodiments, the small ceramic pellets 148 may be configured with a lower density, lighter weight, and/or smaller size than the large ceramic pellets 126. In this case, large ceramic pellets 126 may be larger, heavier, and/or denser than the small ceramic pellets 148.

In embodiments, the small ceramic pellets 148 may tend to remain near the surface of the synthetic turf system 100. By remaining near the surface of the synthetic turf system 100, the small ceramic pellets 148 positioned in the upper layers may interact more directly with environmental factors to which the synthetic turf system 100 may be exposed (e.g., such as water and sunlight). In some cases, the small ceramic pellets 148 disposed in the upper layer may absorb water from rain, irrigation, ambient moisture, etc. This water absorption functionality may operate to contribute to an evaporative cooling effect within the synthetic turf system 100. As the absorbed water evaporates from the small ceramic pellets 148, this may help reduce surface temperatures, and may enhance the thermal comfort of the playing surface.

In embodiments, the large ceramic pellets 146, having a higher density, larger size, and/or heavier weight may be used in the lower layers of the infill of the synthetic turf system 100. The large ceramic pellets 146 may naturally settle or transition towards the bottom of the synthetic turf system 100. The large ceramic pellets 146 in the lower layers may provide functionality that may contribute to the stability of the synthetic turf system 100. The weight and density of the large ceramic pellets 146 may help anchor the synthetic turf fibers 110 and may provide a solid foundation for the playing surface

In embodiments, the layered arrangement of the ceramic pellets 125, 126, and 127 with different properties or characteristics (e.g., different size, density, and/or weight) may allow for a more effective infill system. For example, by disposing ceramic pellets with specific characteristics at different depths within the synthetic turf system 100, various performance aspects of the synthetic turf system 100 (e.g., water management, temperature regulation, structural integrity, etc.) may be controlled at the same time.

With reference back to FIG. 1, in embodiments, the ceramic pellets 120 may be blended with other infill materials to optimize the overall performance of the synthetic turf system 100. The blending of ceramic pellets with other infill materials may provide a balance of desirable properties configured to specific applications, environmental conditions, user requirements, etc. The materials and blend ratios may vary depending on the application and/or use of the synthetic turf system 100. Nonetheless, potential materials for blending may include sand, crumb rubber, and organic infill materials such as coconut husks, walnut shells, cork, or other biodegradable materials.

For example, blending the ceramic pellets 120 with sand may provide enhanced stability and structural support for the synthetic turf system 100, particularly in applications requiring high load-bearing capacity, such as sports fields or heavy-traffic landscaping. Sand may complement the ceramic pellets 120's thermal regulation and water-retention properties by providing a dense, durable base that minimizes turf displacement while allowing for efficient drainage. In some embodiments, a blend of ceramic pellets 120 and sand may include a higher proportion of ceramic pellets 120 in the upper layers of the turf to maximize cooling and shock absorption, while sand may be predominantly disposed within the lower layers of the synthetic turf fibers 110 to enhance stability.

In another example, a blend of ceramic pellets 120 with crumb rubber may be used to leverage the resilience and energy-return properties of crumb rubber and the advanced thermal regulation and water-retention functionality of the ceramic pellets 120. In embodiments, this combination may be particularly advantageous for sports applications, where player safety and performance are very important. Crumb rubber's elasticity may help reduce the impact forces transmitted to athletes, while the ceramic pellets 120's ability to lower surface temperatures may improve player comfort and reduce heat-related risks. The blend ratio may be adjusted depending on the specific requirements of the field. For example, a higher proportion of ceramic pellets 120 may be used in regions with hotter climates to prioritize thermal management.

In embodiments, blending ceramic pellets 120 with organic infill materials, such as coconut husks, walnut shells, or cork, may provide an environmentally friendly solution for synthetic turf systems. Organic infill materials are often lightweight, biodegradable, and provide natural cushioning, making them particularly advantageous for applications where sustainability is important, such as playgrounds, parks, or residential landscaping. When combined with the ceramic pellets 120, the organic infill may improve the synthetic turf system 100's water-retention and cooling functionality while also improving shock absorption. For example, coconut fiber's natural ability to absorb and retain water may complement the ceramic pellets 120's evaporative cooling effect. In some embodiments, the blend may also reduce the overall weight of the infill system, which may facilitate easier installation and maintenance.

In embodiments, the blend ratio of ceramic pellets 120 to other infill materials may vary depending on the intended application. For example, a 50/50 blend of ceramic pellets 120 and cork may prioritize sustainability and cooling for a community park, while a 70/30 blend of ceramic pellets and sand may be used for a sports field requiring durability and heat management. In some embodiments, multi-material blends may also be used. For example, a mixture of ceramic pellets 120, crumb rubber, and cork may be used to leverage the strengths of all three materials, providing thermal regulation, impact absorption, and eco-friendly properties in a single infill system.

In embodiments, the blending of ceramic pellets 120 with other materials may also be configured to reduce the environmental footprint of synthetic turf systems or to improve resistance to wear and compaction. For example, walnut shells may be blended with ceramic pellets to create an infill material that minimizes microplastic pollution while maintaining a stable and resilient surface. Similarly, cork, with inherent thermal insulation properties, may further enhance the cooling effect of the ceramic pellets 120 when blended in particular ratios.

In embodiments, the ceramic pellets 120 may be manufactured from a mixture of materials to achieve particular performance characteristics. For example, in embodiments, the ceramic pellets 120 may include kaolin and bauxite or alumina fines as primary components. In some embodiments, optional sintering aids such as iron oxide or zinc oxide may be included to enhance the strength of the ceramic pellets 120.

In embodiments, the composition and manufacturing process of the ceramic pellets 120 may be configured to produce high-performance infill material for the synthetic turf system 100. In some embodiments, the ceramic pellets 120 may have a hardness ranging from 6 to 8 on the Mohs scale. This hardness range may be configured to achieve the durability and longevity of the ceramic pellets 120 as infill material when subjected to repeated impacts and wear in synthetic turf applications.

Additionally, the bulk density of the ceramic pellets 120 may be configured to range from approximately 0.5 to 2.15 g/cm³. This density range may enable effective distribution of the ceramic pellets 120 within the synthetic turf system 100. The bulk density configuration of the ceramic pellets 120 may also contribute to the stability of the infill layer and may help to maintain consistent playing surface conditions over time.

In some embodiments, the ceramic pellets 120 may be configured to be evenly distributed throughout the synthetic turf fibers 110. This even distribution may help obtain a uniform playing surface and may contribute to the stability and performance of the synthetic turf system 100.

In embodiments, the ceramic pellets 120 may be configured with a consistent roundness and sphericity. This configuration may provide functionality to provide a uniform and free-flowing infill within the synthetic turf system 100. In some embodiments ceramic pellets 120 may have a sphericity and roundness rating of between 0.7 and 0.99, which may provide uniform layering and stability on turf surfaces. This high sphericity and roundness of the ceramic pellets 120 may allow for smooth movement and settling of the infill material within the synthetic turf fibers 110, and may facilitate even distribution of the ceramic pellets 120 throughout the synthetic turf system 100, which may prevent or reduce the formation of compacted areas or voids in the infill layer of the synthetic turf system 100.

In some embodiments, the consistent or uniform roundness or sphericity of the ceramic pellets 120 may allow for improved shock absorption properties, as the ceramic pellets 120 may be able to shift and redistribute more easily under impact. This may be particularly beneficial in sports applications where player safety and consistent playing surface characteristics are important considerations. Furthermore, the high sphericity and roundness rating of the ceramic pellets 120 may enable improved drainage of the synthetic turf system 100, as the consistent shape of the ceramic pellets 120 may allow for the formation of small interstitial spaces between the pellets to allow efficient water flow through the infill layer.

In some embodiments, the uniform shape of the ceramic pellets 120 may facilitate maintenance of the synthetic turf system 100. For example, the consistent roundness of the ceramic pellets 120 may reduce the likelihood of pellet interlocking or compacting over time, which may help maintain the desired infill depth and distribution for extended periods. This may reduce the frequency of required maintenance operations of the synthetic turf system 100.

In some embodiments, the ceramic pellets 120 may be configured to be chemically inert and non-hazardous. This configuration may ensure the overall safety and environmental compatibility of the synthetic turf system 100. For example, the ceramic pellets 120 may be formulated to exclude or minimize the presence of quartz silica. In some embodiments, the ceramic pellets 120 may not include any quartz silica at all. In some other embodiments, the ceramic pellets 120 may include crystalline silica locked in a microstructure of other phases that limits release below a threshold amount or may contain less than a threshold amount of quartz silica to render the ceramic pellets 120 non-hazardous. This may address the health risks associated with silica dust inhalation, which is a concern with traditional infill materials. In some embodiments, the ceramic pellets 120 may be configured to be free from other potentially harmful substances (e.g., other than quartz silica) that may pose risks to users or the environment.

In embodiments, the chemical inertness of the ceramic pellets 120 may also provide benefits to the synthetic turf system 100. For example, the chemical inertness of the ceramic pellets 120 may reduce the likelihood of chemical reactions occurring between the infill material and other components of the turf system or environmental factors such as rainwater or cleaning agents.

In embodiments, the ceramic pellets 120 may be configured with thermal control or thermal regulation properties that enable the synthetic turf system 100 to manage or control the temperature of the surface of the synthetic turf system 100. This functionality may enable the synthetic turf system 100 to obtain cooler surface temperatures compared to traditional infill materials (e.g., crumb rubber and/or sand-based infills). In embodiments, the ceramic pellets 120 may be configured to have lower heat absorption and/or retention characteristics when exposed to sunlight. This configuration may allow the ceramic pellets 120 to not absorb heat and/or release absorbed heat more efficiently and may contribute to a lower overall temperature of the turf surface of the synthetic turf system 100.

In some embodiments, the thermal control properties of the ceramic pellets 120 may include configuration of various factors associated with the ceramic pellets 120, such as material composition, surface treatment, color, shading, etc. In some embodiments, the solar absorption (e.g., the fraction of solar energy the ceramic pellets 120 absorbs, where 1 represents full and total absorption) of the ceramic pellets 120 may be between 0.15-0.90. In some embodiments, the solar absorption of the ceramic pellets 120 may be less than 0.3.

In some embodiments, the ceramic pellets 120 may be configured with different heat control properties based on their size and density. For example, smaller or less dense ceramic pellets may be configured with enhanced heat control features, such as lighter colors, reflective surfaces, or specific material compositions that promote heat dissipation. Conversely, larger or denser ceramic pellets may not include these heat control properties. This configuration may be particularly advantageous in layered infill structures, where larger (if same density as smaller pellets) or less dense pellets tend to remain near the surface of the synthetic turf system 100, while smaller (if same density as larger pellets) or denser pellets settle towards the bottom layers. By focusing heat control measures on the upper layer pellets, which are more likely to be exposed to direct sunlight, the synthetic turf system 100 may achieve improved thermal management efficiency without unnecessarily applying heat control features to pellets that are less likely to impact surface temperatures.

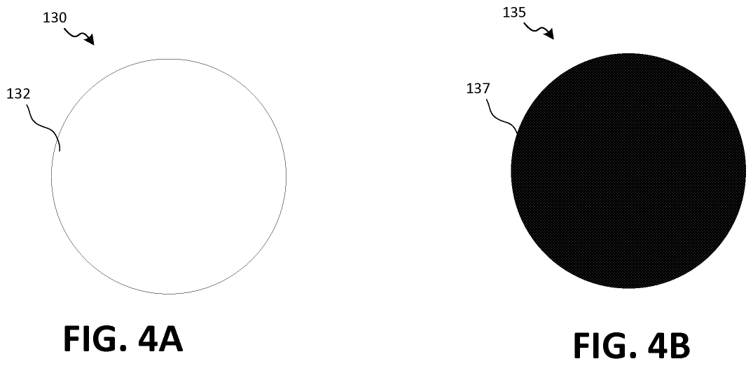

In some embodiments, the thermal regulation properties of the ceramic pellets 120 may include configuring the color of the ceramic pellets 120 to configure the heat control properties of the ceramic pellets 120. For example, in embodiments, the ceramic pellets 120 may be colored with lighter colors that may not absorb or may release heat more readily to configure the ceramic pellets 120 with a low heat retention. On the other hand, where a low heat retention is not required (e.g., in cooler environments or low sunlight environments), the ceramic pellets 120 may be colored with darker colors that may absorb or may retain heat more readily to configure the ceramic pellets 120 with a high heat retention. For example, as shown in FIG. 4A, the ceramic pellet 130 may have a surface 132 that is colored with a light color (e.g., yellow in this non-limiting example, but may be colored any color lighter than a threshold color value for considering a color as a light color). In this example, the ceramic pellet 130 may be configured as a low-heat retention ceramic pellet and may be configured to release heat more readily. On the other hand, in the example shown in FIG. 4B, the ceramic pellet 135 may have a surface 137 that is colored with a dark color (e.g., black in this non-limiting example, but may be colored any color darker than a threshold color value for considering a color as a dark color). In this example, the ceramic pellet 135 may be configured as a high-heat retention ceramic pellet and may be configured to retain heat more readily rather than releasing it.

In some embodiments, the color configuration of a ceramic pellet may include various shading options within the same color family. In some embodiments, a first ceramic pellet may be configured with a lighter shading of a first color and a second ceramic pellet may be configured with a darker shading of the same first color. In this example, the first ceramic pellet may be configured to retain less heat than the second ceramic pellet. In this example, the first ceramic pellet may contribute to a cooler surface temperatures in the synthetic turf system 100, and the second ceramic pellet with the darker shading of the same color may contribute to a higher surface temperatures in the synthetic turf system 100. In some embodiments, more than one color may be used for a single ceramic pellet.

In some implementations, the synthetic turf system 100 may include ceramic pellets 120 with a range of different colors, and/or with a range of shading within a single color spectrum. This may allow for fine-tuning of the heat control properties across different areas or layers of the infill. For example, ceramic pellets 120 with lighter colors and/or shading may be used in upper layers or areas more exposed to direct sunlight, while ceramic pellets 120 with darker colors and/or shading may be used in lower layers or less exposed areas.

In embodiments, the thermal regulation properties of the ceramic pellets 120 may include configuring the surface characteristics of the ceramic pellets 120 to configure the heat control properties of the ceramic pellets 120. For example, in embodiments, the roughness or smoothness of the surface of a ceramic pellet may be configured to control how the ceramic pellet may interact with light and heat. For example, ceramic pellets 120 with a rougher surface texture may scatter incoming light more effectively, which may reduce direct heat absorption, render them cooler. On the other hand, ceramic pellets 120 with a smoother surface may have different reflective properties, which may influence their heat retention and dissipation characteristics.

In embodiments, roughing the surface of a ceramic pellet of the ceramic pellets 120 may include applying additional treatments after the initial formation of the ceramic pellet to obtain the intended roughness characteristics. These treatments may include mechanical abrasion, chemical etching, the application of textured coating, etc. In some embodiments, the roughness may be configured with specific surface patterns or structures that enhance the thermal regulation of the ceramic pellet.

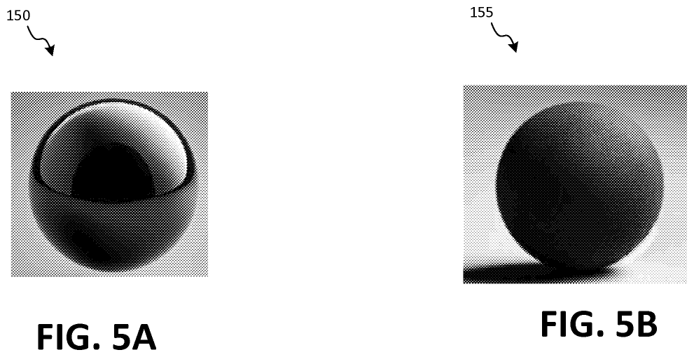

In embodiments, the thermal regulation properties of the ceramic pellets 120 may include configuring the reflectivity of the ceramic pellets 120. In embodiments, configuring the reflectivity of the ceramic pellets 120 may include configuring the surface finish of the ceramic pellets 120 to create varying degrees of glossiness or dullness, which may affect how the ceramic pellets 120 interact with sunlight and heat. For example, as shown in FIG. 5A, which shows a ceramic pellet 150 having a glossy surface, a ceramic pellet with a glossy surface finish may reflect more sunlight, which may reduce the heat retention and/or absorption of the ceramic pellet, rendering the ceramic pellet cooler. On the other hand, as shown in FIG. 5B, which shows a ceramic pellet 150 having a matte surface, a ceramic pellet with a matte or less glossy surface finish may absorb and/or retain more heat.

In embodiments, configuring the reflectivity of a ceramic pellet may include polishing or buffing the ceramic pellet to obtain the intended level of reflectivity of the ceramic pellet (e.g., the level of glossiness). In some embodiments, the surface of the ceramic pellet may be roughened or treated to produce the intended level of absorption of the ceramic pellet (e.g., the level of dullness). In embodiments, the level of glossiness or dullness may be fine-tuned to obtain specific thermal regulation properties within the synthetic turf system 100.

In some embodiments, the ceramic pellets 120 may include a mixture of ceramic pellets with different surface finishes (e.g., ceramic pellets of different levels of glossiness and/or dullness). For example, glossy ceramic pellets may be used in portions of the synthetic turf system 100 that may be more exposed to sunlight, while matte ceramic pellets may be utilized in portions of the synthetic turf system 100 that are less exposed to sunlight.

In some embodiments, the thermal regulation properties of the ceramic pellets 120 may include configuring the ceramic pellets 120 to retain water and/or moisture. This water-retention functionality may be advantageous to the synthetic turf system 100, particularly in managing and/or controlling heat accumulation on the surface of the synthetic turf system 100. For example, the ceramic pellets 120 may absorb moisture from various sources (e.g., rain, irrigation, ambient humidity, etc.), which may then evaporate when exposed to heat, contributing to an evaporative cooling effect. This evaporative process may operate to lower the surface temperature of the synthetic turf system 100. To optimize this functionality, the ceramic pellets 120 may be configured with specific and/or particular porosity, surface texture, material composition, etc. to maximize water absorption and retention while maintaining structural integrity and durability.

In embodiments, the water-retention functionality of the ceramic pellets 120 may dynamically interact with physical activity on the synthetic turf system 100. For example, as the ceramic pellets 120 are agitated by walking, running, jumping, etc. on the surface of the synthetic turf system 100, the agitation may cause the water retained within the ceramic pellets 120 to be drawn toward the surface of the pellets. This action may facilitate the evaporative cooling effect by ensuring that water reaches the outer surface of the ceramic pellets, where it may evaporate and effectively reduce surface temperature. In some embodiments, the water retained within the ceramic pellets 120 may operate as an insulating layer, further enhancing the heat control properties by reducing heat transfer to the surrounding environment. This functionality may be particularly advantageous for applications in sports fields, playgrounds, or high-traffic areas, where user activity generates heat and where surface overheating is a common concern.

In some embodiments, the functionality of the ceramic pellets 120 for thermal regulation through moisture retention and release may enable the synthetic turf system 100 to reduce the reliance on external cooling measures such as artificial irrigation or shading structures. In some embodiments, the water-retention and evaporative cooling functionality of the ceramic pellets 120 may be configurable to specific applications by adjusting their physical and chemical properties. For example, ceramic pellets with higher porosity and finer surface textures may be used in areas requiring enhanced cooling performance, while less porous pellets may be used in applications with lower ambient temperatures or less direct sunlight.

In embodiments, the heat-regulation configuration of the ceramic pellets 120 may be based on the expected temperature exposure of the synthetic turf system 100. For example, ceramic pellets 120 intended for use in high-temperature applications may be configured with enhanced heat-release properties to facilitate heat dissipation, while ceramic pellets 120 intended for cooler applications may have higher color retention configuration to maintain optimal surface temperatures for the synthetic turf system 100.

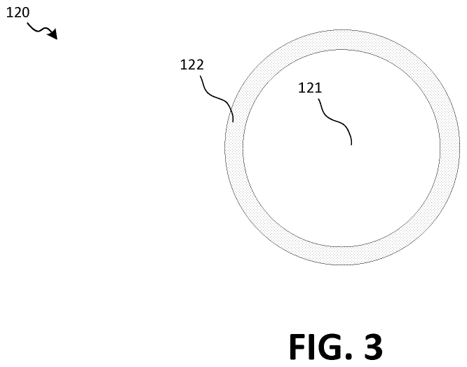

In embodiments, configuring a ceramic pellet with a particular heat regulation or control functionality (e.g., a particular color configuration, surface roughness, surface reflectivity, etc.), may include coating the ceramic pellet with a coating configured to achieve the intended heat regulation configuration. For example, FIG. 3 shows an exemplary ceramic pellet 120 with a coating for configuring the ceramic pellet 120 with heat regulation functionality in accordance with embodiments of the present disclosure.

As shown in FIG. 3, the ceramic pellet 120 may include a ceramic pellet core 121 and a coating 122. In embodiments, the ceramic pellet core 121 may include a ceramic pellet, such as ceramic pellet that has been previously fired into a ceramic pellet by a ceramic pellet manufacturing process. In embodiments, the coating 122 may be applied to the ceramic pellet core 121 to modify the heat-retention properties of the ceramic pellet core 121 and to produce the ceramic pellet 120. In some embodiments, the coating 122 may include a resin or polyurethane material having a particular color, reflectivity, roughness, and/or other heat-retention configuration.

In embodiments, the coating 122 may be applied to the ceramic pellet core 121 using various techniques, such as spray coating, dip coating, powder coating, etc. In some embodiments, the coating process may be carried out after the formation of the ceramic pellet core 121. In embodiments, the thickness of the coating 122 may be configured to obtain a particular color intensity and/or durability. In some embodiments, a thicker coating may provide enhanced color stability and resistance to wear, while a thinner coating may allow for more of the ceramic pellet core 121's properties to influence the overall performance of the ceramic pellet 120.

In embodiments, where coating 122 is a color coating, the color of the coating 122 may be selected based on various factors, including thermal properties, aesthetic considerations, specific application requirements, etc. For example, lighter colored coatings may be used to enhance heat reflection, while darker coatings may be employed in situations where heat retention is beneficial. In some embodiments, the coating 122 may include UV stabilizers to improve color retention and prevent fading over time. In some additional or alternative embodiments, the surface texture of the coating may be modified to influence light reflection or water interaction properties.

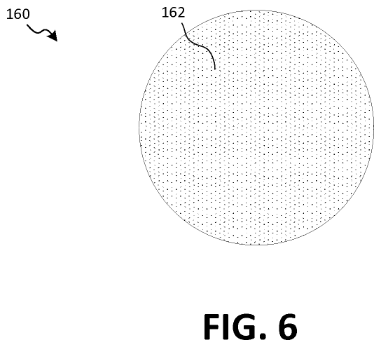

In embodiments, the ceramic pellets 120 may be configured with functionality to include other materials for controlling various characteristics of the ceramic pellets 120. For example, as shown in FIG. 6, in some embodiments, the porosity of the ceramic pellets 120 may be configured to allow for the infusion of additional materials, which may enhance or modify the properties of the ceramic pellets 120 to function as infill within the synthetic turf system 100. For example, as shown in FIG. 6, ceramic pellet 160 may be configured with a level of porosity 162 that is configured to allow ceramic pellet 160 to be infused with additional materials.

For example, in some embodiments, particular oxides and/or other suitable materials may be infused into the ceramic pellets 120 to address environmental concerns such as microplastic pollution. In one particular embodiments, indium oxide may be infused into the ceramic pellets 120 to reduce the amount of microplastics that may run off into water systems from the synthetic turf system 100.

In some embodiments, the ceramic pellets 120 may be infused with materials that provide additional functionalities beyond environmental protection. For example, in some embodiments, citronella and/or other animal-repellent substances may be included into the ceramic pellets 120 to create an infill with insect or animal-repelling properties. In additional or alternative embodiments, the ceramic pellets 120 may be infused with urine neutralizers, which may be particularly useful in synthetic turf systems 100 that may be installed in areas frequented by pets or wildlife and may help mitigate odors and damage caused by animal urine.

In embodiments, infusing the additional materials into the ceramic pellets 120 may include adding the additional materials to the ceramic mixture before the ceramic pellets 120 are formed and sintered. This may allow for a more uniform distribution of the additional materials throughout the ceramic pellet structure. Alternatively, or additionally, the ceramic pellets 120 may be coated with the additional materials after formation. This may provide flexibility in applying different treatments to batches of ceramic pellets 120, which may allow for customization of the properties of the ceramic pellets 120 based on specific installation requirements or environmental conditions.

The following provides descriptions of specific examples of ceramic pellets that may be provided as the ceramic pellets 120 for infill material for the synthetic turf system 100 in accordance with embodiments of the present disclosure. It is noted that these examples illustrate the various properties and characteristics available in different types of ceramic pellets that may be provided as the ceramic pellets 120, including variations in density, hardness, particle size distribution, and/or other performance attributes. Each example type of ceramic pellet may be described in a separate table to provide a comprehensive overview of the specific properties, including mesh size distributions and physical characteristics.

It should be noted that the following examples are not intended to be exhaustive or limiting in any way. Rather, these non-limiting examples are provided to highlight the variability in the configuration of the ceramic pellets 120 to meet the requirements of different synthetic turf applications. Indeed, it is contemplated that additional ceramic pellet configurations may also be used within the scope of this disclosure, depending on the desired performance characteristics and application-specific needs.

Tables 1A and 1B provide specific characteristics of a first type of ceramic pellet, which may be an example of high-performance ceramic media configured for synthetic turf infill. This first type of ceramic pellet may exhibit low density, consistent roundness, and sphericity, making it a cost-effective and durable choice for various applications. Table 1A below includes details on the general properties of the first type of ceramic pellet.

TABLE 1A
General Properties of the First Type of Ceramic Pellet

| Property | Value | |
|---|---|---|
| Bulk Density | 1.56 g/cm³ (96 lb/ft³) | |
| Apparent Density | 2.70 | g/cm³ |
| Absolute Volume | 0.044 | gal/lb |

| | |
|---|---|
| Hardness (Mohs) | 6+ |
| Vickers Hardness (HV) | 742 |
| Roundness | 0.9 |
| Sphericity | 0.9 |

Table 1B below includes details on the mesh size distribution for the first type of ceramic pellet.

TABLE 1B
Mesh Size Distribution for the First Type of Ceramic Pellet

| | | | 20/40 | 30/50 | 40/70 |
|---|---|---|---|---|---|
| U.S. Mesh | Micron Range | | Sieve (%) | Sieve (%) | Sieve (%) |
| −4 + 6 | −4750 + 3350 | μm | | | |
| −6 + 8 | −3350 + 2360 | μm | | | |
| −8 + 12 | −2360 + 1700 | μm | | | |
| −12 + 16 | −1700 + 1180 | μm | | | |
| −16 + 20 | −1180 + 850 | μm | 5 | | |
| −20 + 30 | −850 + 600 | μm | 60 | 3 | |
| −30 + 40 | −600 + 425 | μm | 35 | 79 | 1 |
| −40 + 50 | −425 + 300 | μm | | 17 | 80 |
| −50 + 70 | −300 + 212 | μm | | 1 | 18 |

| | | | | |
|---|---|---|---|---|
| −70 | −212 | | | 1 |
| Median | | 635 | 473 | 334 |
| Particle | | | | |
| Diameter | | | | |
| (μm) | | | | |

Tables 2A and 2B provide specific characteristics of a second type of ceramic pellet, which may be an example of high-performance ceramic media configured for synthetic turf infill. This second type of ceramic pellet may exhibit low density, enhanced hardness, and exceptional sphericity, making it suitable for applications that require high durability and performance. Table 2A below includes details on the general properties of the second type of ceramic pellet.

TABLE 2A
General Properties of the Second Type of Ceramic Pellet

| Property | Value | |
|---|---|---|
| Bulk Density | 1.57 g/cm³ (97 lb/ft³) | |
| Apparent Density | 2.71 | g/cm³ |
| Absolute Volume | 0.044 | gal/lb |

| | |
|---|---|
| Hardness (Mohs) | 7+ |
| Vickers Hardness (HV) | 816 |
| Roundness | 0.9 |
| Sphericity | 0.9 |

Table 2B below includes details on the mesh size distribution for the second type of ceramic pellet.

TABLE 2B
Mesh Size Distribution for the Second Type of Ceramic Pellet

| U.S. | | 5/8 | 8/14 | 12/18 | 16/20 | 20/40 | 30/50 | 40/70 |
|---|---|---|---|---|---|---|---|---|
| Mesh | Micron Range | Sieve | Sieve | Sieve | Sieve | Sieve | Sieve | Sieve |
| −4 + 6 | −4750 + 3350 μm | 11 | | | | | | |
| −6 + 8 | −3350 + 2360 μm | 89 | 1 | | | | | |
| −8 + 12 | −2360 + 1700 μm | | 89 | 4 | | | | |
| −12 + 16 | −1700 + 1180 μm | | 10 | 91 | 5 | | | |
| −16 + 20 | −1180 + 850 μm | | | 5 | 93 | 7 | | |
| −20 + 30 | −850 + 600 μm | | | | 2 | 90 | 4 | |
| −30 + 40 | −600 + 425 μm | | | | | 3 | 90 | 1 |
| −40 + 50 | −425 + 300 μm | | | | | | 6 | 80 |
| −50 + 70 | −300 + 212 μm | | | | | | | 18 |
| −70 | −212 | | | | | | | 1 |
| Median | | 2925 | 1897 | 1374 | 1001 | 730 | 522 | 334 |
| Particle | | | | | | | | |
| Diameter | | | | | | | | |
| (μm) | | | | | | | | |

Tables 3A and 3B provide specific characteristics of a third type of ceramic pellet, which may be an example of high-performance ceramic media configured for synthetic turf infill. This third type of ceramic pellet may exhibit intermediate density, high hardness, and exceptional roundness and sphericity, making it ideal for high-performance synthetic turf applications. Table 3A below includes details on the general properties of the third type of ceramic pellet.

TABLE 3A
General Properties of the Third Type of Ceramic Pellet

| Property | Value | |
|---|---|---|
| Bulk Density | 1.88 g/cm³ (117 lb/ft³) | |
| Apparent Density | 3.27 | g/cm³ |
| Absolute Volume | 0.037 | gal/lb |

| | |
|---|---|
| Hardness (Mohs) | 8+ |
| Vickers Hardness (HV) | 1120 |
| Roundness | 0.9 |
| Sphericity | 0.9 |

Table 3B below includes details on the mesh size distribution for the third type of ceramic pellet.

TABLE 3B
Mesh Size Distribution for the Third Type of Ceramic Pellet

| | Micron | | | | | | | | | | |
|---|---|---|---|---|---|---|---|---|---|---|---|
| U.S. | Range | 12/18 | 16/30 | 20/40 | 30/60 | 30/70 | 40/70 | 40/100 | 40/140 | 50/140 | 70/140 |
| Mesh | (μm) | Sieve | Sieve | Sieve | Sieve | Sieve | Sieve | Sieve | Sieve | Sieve | Sieve |
| −4 + 6 | −4750 + 3350 | | | | | | | | | | |
| −6 + 8 | −3350 + 2360 | | | | | | | | | | |
| −8 + 12 | −2360 + 1700 | 2 | | | | | | | | | |
| −12 + 16 | −1700 + 1180 | 82 | 3 | | | | | | | | |
| −16 + 20 | −1180 + 850 | 16 | 74 | 4 | | | | | | | |
| −20 + 30 | −850 + 600 | | 23 | 75 | 3 | | | | | | |
| −30 + 40 | −600 + 425 | | | 21 | 68 | 19 | 3 | | | | |
| −40 + 50 | −425 + 300 | | | | 28 | 72 | 70 | 37 | 22 | | |
| −50 + 70 | −300 + 212 | | | | 1 | 26 | 26 | 45 | 38 | 35 | 1 |
| −70 + 100 | −212 + 149 | | | | | 1 | 1 | 16 | 32 | 43 | 51 |
| −100 + 140 | −149 + 105 | | | | | | | 2 | 8 | 21 | 43 |
| −140 + 200 | −105 + 74 | | | | | | | | | 1 | 5 |
| Median | | 1328 | 936 | 672 | 453 | 361 | 324 | 270 | 231 | 194 | 154 |
| Particle | | | | | | | | | | | |
| Diameter | | | | | | | | | | | |
| (μm) | | | | | | | | | | | |

Tables 4A and 4B provide specific characteristics of a fourth type of ceramic pellet, which may be an example of high-performance ceramic media configured for synthetic turf infill. This fourth type of ceramic pellet may exhibit intermediate density, high hardness, and exceptional roundness and sphericity, making it ideal for high-performance synthetic turf applications. Table 4A below includes details on the general properties of the fourth type of ceramic pellet.

TABLE 4A
General Properties of the Fourth Type of Ceramic Pellet

| Property | Value | |
|---|---|---|
| Bulk Density | 2.10 g/cm³ (131 lb/ft³) | |
| Apparent Density | 3.61 | g/cm³ |
| Absolute Volume | 0.033 | gal/lb |

| | |
|---|---|
| Hardness (Mohs) | 8+ |
| Vickers Hardness (HV) | 1248 |
| Roundness | 0.9 |
| Sphericity | 0.9 |

Table 4B below includes details on the mesh size distribution for the fourth type of ceramic pellet.

TABLE 4B
Mesh Size Distribution for the Fourth Type of Ceramic Pellet

| | Micron Range | | 16/30 | 20/40 | 30/60 |
|---|---|---|---|---|---|
| U.S. Mesh | (μm) | | Sieve | Sieve | Sieve |
| −4 + 6 | −4750 + 3350 | μm | | | |
| −6 + 8 | −3350 + 2360 | μm | | | |
| −8 + 12 | −2360 + 1700 | μm | | | |
| −12 + 16 | −1700 + 1180 | μm | 3 | | |
| −16 + 20 | −1180 + 850 | μm | 85 | 4 | |
| −20 + 30 | −850 + 600 | μm | 12 | 85 | 5 |
| −30 + 40 | −600 + 425 | μm | | 11 | 87 |
| −40 + 50 | −425 + 300 | μm | | | 8 |

| | | | | |
|---|---|---|---|---|
| −50 + 70 | −300 + 210 | | | |
| −70 + 100 | −210 + 150 | | | |
| Median | | 956 | 697 | 495 |
| Particle | | | | |
| Diameter | | | | |
| (μm) | | | | |

Tables 5A-5D provide specific characteristics of a fifth type of ceramic pellet, which may be an example of high-performance ceramic media configured for synthetic turf infill. In embodiments, the fifth type of ceramic pellet may have two distinct variants, a low-density variant and a high-density variant. Table 5A below includes details on the general properties of the low-density variant of the fifth type of ceramic pellet.

TABLE 5A
General Properties of the Low-Density Variant
of the Fifth Type of Ceramic Pellet

| Property | Value | |
|---|---|---|
| Bulk Density | 1.67 g/cm³ (104 lb/ft³) | |
| Apparent Density | 2.83 | g/cm³ |
| Absolute Volume | 0.042 | gal/lb |

| | |
|---|---|
| Hardness (Mohs) | 7+ |
| Vickers Hardness (HV) | 1065 |
| Roundness | 0.9 |
| Sphericity | 0.9 |

Table 5C below includes details on the general properties of the high-density variant of the fifth type of ceramic pellet.

TABLE 5C
General Properties of the High-Density Variant
of the Fifth Type of Ceramic Pellet

| Property | Value | |
|---|---|---|
| Bulk Density | 2.14 g/cm³ (134 lb/ft³) | |
| Apparent Density | 3.60 | g/cm³ |
| Absolute Volume | 0.033 | gal/lb |

| | |
|---|---|
| Hardness (Mohs) | 8+ |
| Vickers Hardness (HV) | 1431 |
| Roundness | 0.9 |
| Sphericity | 0.9 |
| Median Particle Diameter | 1374 |
| (μm) | |

Table 5B below includes details on the mesh size distribution for the low-density variant of the fifth type of ceramic pellet.

TABLE 5B
Mesh Size Distribution for the Low-Density
Variant of the Fifth Type of Ceramic Pellet

| U.S. Mesh | Micron Range | | 25 Sieve (%) | 35 Sieve (%) |
|---|---|---|---|---|
| −4 + 6 | −4750 + 3350 | μm | | |
| −6 + 8 | −3350 + 2360 | μm | | |
| −8 + 12 | −2360 + 1700 | μm | | |
| −12 + 16 | −1700 + 1180 | μm | | |
| −16 + 20 | −1180 + 850 | μm | | |
| −20 + 30 | −850 + 600 | μm | 100 | |
| −30 + 40 | −600 + 425 | μm | | 100 |
| −40 + 50 | −425 + 300 | μm | | |
| −50 + 70 | −300 + 212 | μm | | |

| | | | |
|---|---|---|---|
| −70 | −212 | | |
| Median | | 810 | 575 |
| Particle | | | |
| Diameter | | | |
| (μm) | | | |

Table 5D below includes details on the mesh size distribution for the high-density variant of the fifth type of ceramic pellet.

TABLE 5D
Mesh Size Distribution for the High-Density
Variant of the Fifth Type of Ceramic Pellet

| | | | 20 Sieve | 25 Sieve | 35 Sieve |
|---|---|---|---|---|---|
| U.S. Mesh | Micron Range | | (%) | (%) | (%) |
| −4 + 6 | −4750 + 3350 | μm | | | |
| −6 + 8 | −3350 + 2360 | μm | | | |
| −8 + 12 | −2360 + 1700 | μm | | | |
| −12 + 16 | −1700 + 1180 | μm | | | |
| −16 + 20 | −1180 + 850 | μm | 100 | | |
| −20 + 30 | −850 + 600 | μm | | 100 | |
| −30 + 40 | −600 + 425 | μm | | | 100 |
| −40 + 50 | −425 + 300 | μm | | | |
| −50 + 70 | −300 + 212 | μm | | | |

| | | | | |
|---|---|---|---|---|
| −70 | −212 | | | |
| Median | | 960 | 815 | 580 |
| Particle | | | | |
| Diameter | | | | |
| (μm) | | | | |

Tables 6A-6D provide specific characteristics of a sixth type of ceramic pellet, which may be an example of high-performance ceramic media configured for synthetic turf infill. In embodiments, the sixth type of ceramic pellet may have two distinct variants, a low-density variant and a high-density variant. Table 6A below includes details on the general properties of the low-density variant of the sixth type of ceramic pellet.

TABLE 6A
General Properties of the Low-Density Variant
of the Sixth Type of Ceramic Pellet

| Property | Value | |
|---|---|---|
| Bulk Density | 1.67 g/cm³ (104 lb/ft³) | |
| Apparent Density | 2.83 | g/cm³ |
| Absolute Volume | 0.042 | gal/lb |

| | |
|---|---|
| Hardness (Mohs) | 7+ |
| Vickers Hardness (HV) | 1065 |
| Roundness | 0.9 |
| Sphericity | 0.9 |

Table 6B below includes details on the general properties of the high-density variant of the sixth type of ceramic pellet.

TABLE 6B
General Properties of the High-Density Variant
of the Sixth Type of Ceramic Pellet

| Property | Value | |
|---|---|---|
| Bulk Density | 2.14 g/cm³ (134 lb/ft³) | |
| Apparent Density | 3.60 | g/cm³ |
| Absolute Volume | 0.033 | gal/lb |

| | |
|---|---|
| Hardness (Mohs) | 8+ |
| Vickers Hardness (HV) | 1431 |
| Roundness | 0.9 |
| Sphericity | 0.9 |

Table 6C below includes details on the mesh size distribution for the low-density variant of the sixth type of ceramic pellet.

TABLE 6C
Mesh Size Distribution for the Low-Density
Variant of the Sixth Type of Ceramic Pellet

| | | | 18/20 | 20/25 | 30/35 |
|---|---|---|---|---|---|
| U.S. Mesh | Micron Range | | Sieve | Sieve | Sieve |
| −4 + 6 | −4750 + 3350 | μm | | | |
| −6 + 8 | −3350 + 2360 | μm | | | |
| −8 + 12 | −2360 + 1700 | μm | | | |
| −12 + 16 | −1700 + 1180 | μm | | | |
| −16 + 20 | −1180 + 850 | μm | 93 | | |
| −20 + 30 | −850 + 600 | μm | 7 | 100 | |
| −30 + 40 | −600 + 425 | μm | | | 100 |
| −40 + 50 | −425 + 300 | μm | | | |
| −50 + 70 | −300 + 212 | μm | | | |

| | | | | |
|---|---|---|---|---|
| −70 | −212 | | | |
| Median | | 900 | 810 | 575 |
| Particle | | | | |
| Diameter | | | | |
| (μm) | | | | |

Table 6D below includes details on the mesh size distribution for the high-density variant of the sixth type of ceramic pellet.

TABLE 6D
Mesh Size Distribution for the High-Density
Variant of the Sixth Type of Ceramic Pellet

| | | |
|---|---|---|
| U.S. Mesh | Micron Range | 20/25 Sieve |

| | | | |
|---|---|---|---|
| −4 + 6 | −4750 + 3350 | μm | |
| −6 + 8 | −3350 + 2360 | μm | |
| −8 + 12 | −2360 + 1700 | μm | |
| −12 + 16 | −1700 + 1180 | μm | |
| −16 + 20 | −1180 + 850 | μm | |
| −20 + 30 | −850 + 600 | μm | 100 |
| −30 + 40 | −600 + 425 | μm | |
| −40 + 50 | −425 + 300 | μm | |
| −50 + 70 | −300 + 212 | μm | |

| | | |
|---|---|---|
| −70 | −212 | |
| Median | | 815 |
| Particle | | |
| Diameter | | |
| (μm) | | |

Tables 7A and 7B provide specific characteristics of a seventh type of ceramic pellet, which may be an example of high-performance ceramic media configured for synthetic turf infill. This seventh type of ceramic pellet may exhibit small particle size, high durability, and chemically inert composition, making it ideal for precise applications and enhanced performance. Table 7A below includes details on the general properties of the seventh type of ceramic pellet.

TABLE 7A
General Properties of the Seventh Type of Ceramic Pellet

| Property | Value |
|---|---|
| Bulk Density | 0.95-1.45 g/cm³ (59-91 lb/ft³) |
| Median Particle Diameter | Ranges from 330 to 3100 |
| (μm) | depending on mesh size |
| Uniformity Index (D60/D10) | 1.13-1.20 depending on mesh |
| | size |
| Chemical Composition | Aluminosilicate ceramic |
| Roundness | High |
| Sphericity | High |
| Features | Chemically inert, non-hazardous, |
| | no respirable silica dust |

Table 7B below includes details on the mesh size distribution for the Seventh type of ceramic pellet.

TABLE 7B
Mesh Size Distribution for the Seventh Type of Ceramic Pellet

| U.S. | Micron Range | 5/8 | 8/14 | 12/18 | 16/20 | 20/40 | 30/50 | 40/70 |
|---|---|---|---|---|---|---|---|---|
| Mesh | (μm) | Sieve | Sieve | Sieve | Sieve | Sieve | Sieve | Sieve |
| −4 + 6 | −4750 + 3350 μm | 21 | | | | | | |
| −6 + 8 | −3350 + 2360 μm | 79 | 1 | | | | | |
| −8 + 12 | −2360 + 1700 μm | | 89 | 4 | | | | |
| −12 + 16 | −1700 + 1180 μm | | 10 | 91 | 5 | | | |
| −16 + 20 | −1180 + 850 μm | | | 5 | 93 | 5 | | |
| −20 + 30 | −850 + 600 μm | | | | 2 | 66 | 8 | |
| −30 + 40 | −600 + 425 μm | | | | | 29 | 87 | 5 |
| −40 + 50 | −425 + 300 μm | | | | | | 5 | 42 |
| −50 + 70 | −300 + 210 | | | | | | | 50 |
| −70 + 100 | −210 + 150 | | | | | | | 3 |
| Median | | 3.10 | 1.90 | 1.37 | 1.00 | 0.73 | 0.54 | 0.33 |
| Particle | | | | | | | | |
| Diameter | | | | | | | | |
| (μm) | | | | | | | | |

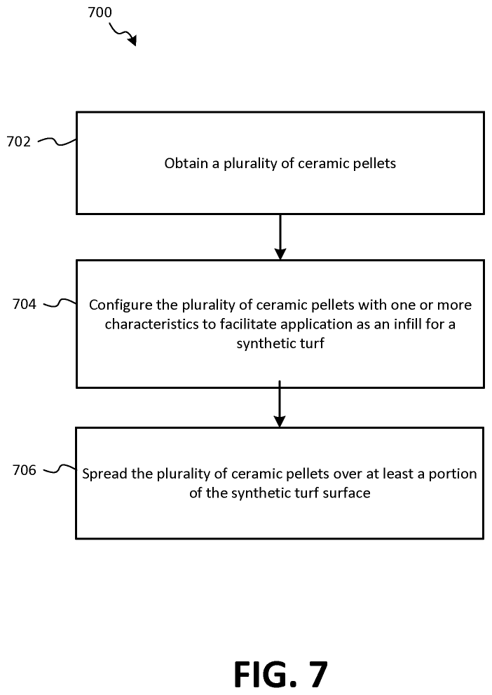

Operation of the synthetic turf system 100 will now be discussed with respect to FIG. 7, in accordance with embodiments of the present disclosure. FIG. 7 shows a high-level flow diagram 700 of operations for installing an infill of the synthetic turf system 100. In particular, high-level flow diagram 700 shows operations for installing the ceramic pellets (e.g., the ceramic pellets 120) into a synthetic turf system (e.g., the synthetic turf system 100).

At block 702, a plurality of ceramic pellets is obtained. For example, obtaining the plurality of ceramic pellets (e.g., the ceramic pellets 120) may include acquiring or manufacturing the ceramic pellets that may operate as the infill material for the synthetic turf system. In embodiments, the ceramic pellets may be produced according to specifications that optimize their performance as infill, such as specific size ranges, densities, compositions, heat-regulation configuration, etc.

At block 704, the plurality of ceramic pellets is configured with one or more characteristics to facilitate application as an infill for a synthetic turf. For example, various properties of the ceramic pellets may be configured or set to configure their functionality within the synthetic turf system. For example, the ceramic pellets may be treated to modify their surface characteristics (e.g., roughness, reflectivity, etc.), coated to achieve particular color properties, infused with additional materials, etc.

In some embodiments, configuring the plurality of ceramic pellets with one or more characteristics to facilitate application as an infill for a synthetic turf may include sorting the ceramic pellets by size or density to create layered infill structures. Additionally, coatings or treatments may be applied to the ceramic pellets to control thermal properties, enhance durability, add specific functionalities such as insect repellence or odor neutralization, etc.

At block 706, the plurality of ceramic pellets is spread over at least a portion of the synthetic turf surface. In embodiments, spreading the plurality of ceramic pellets at least a portion of the synthetic turf surface may include distributing the configured ceramic pellets across the synthetic turf to create the infill layer. The spreading of the plurality of ceramic pellets over at least a portion of the synthetic turf surface may be carried out using specialized equipment designed for even distribution of infill materials, and/or using standard infill equipment.

In some embodiments, spreading the plurality of ceramic pellets over at least a portion of the synthetic turf surface may be performed in multiple passes to achieve desired infill depths or to create layered structures with different types of ceramic pellets. This may include additional steps such as brushing or grooming the turf surface to ensure proper settling of the ceramic pellets between the synthetic turf fibers. In some embodiments, due to the consistent pellet size and shape of the ceramic pellet, the ceramic infill may not require extensive grooming or leveling, unlike conventional infill materials, which may require compaction and frequent maintenance.

In embodiments, the streamlined installation process enabled by the configuration of the ceramic pellets of embodiments, may result in an installation process that is significantly reduced when compared to the installation of conventional infill materials.

In addition, the ceramic pellets and the synthetic turf systems of embodiments provide significant advantages over conventional infill materials. For example, crumb rubber, which is known for its resilience, has long been used as an infill material. However, it is prone to retaining heat, often leading to surface temperatures as much as 40° F. higher than ambient air temperature on sunny days. Additionally, crumb rubber infill may contain heavy metals and other contaminants from recycled tires, raising environmental and health concerns. Silica sand, while more affordable, is associated with the risk of silicosis due to fine dust particles released during use. It also lacks resilience and requires frequent re-leveling to maintain turf integrity.

Tests were conducted to evaluate the durability, health impact, and thermal performance of ceramic infill compared to conventional materials. The ceramic infill demonstrated superior performance in maintaining lower surface temperatures and showed negligible dust production under high-stress conditions.

Ceramic infill particles, subjected to UV exposure and mechanical wear, retained over 95% of their initial structural integrity after six months of accelerated testing, significantly outperforming crumb rubber and silica sand in similar conditions.

Infrared thermometers measured surface temperatures across different infill types. Ceramic infill-infused turf consistently recorded 15-20° F. lower temperatures than crumb rubber-filled turf on clear, sunny days with ambient temperatures above 90° F.

Silica dust release levels were measured across various infill types, with ceramic pellets producing minimal respirable dust, thereby reducing risks of inhalation-related diseases.

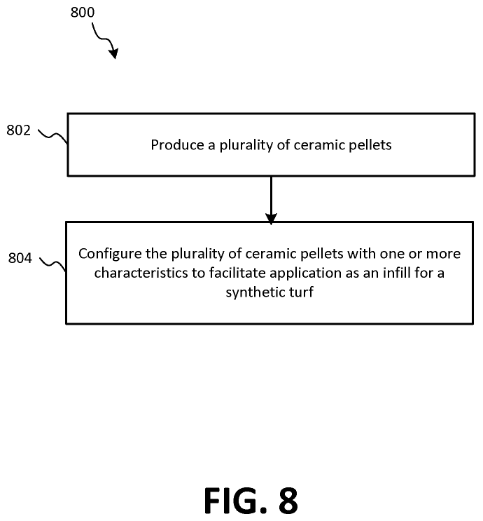

FIG. 8 shows an exemplary flow diagram 800 of operations for manufacturing ceramic pellets for use as infill material for a synthetic turf system configured with functionality in accordance with embodiments of the present disclosure. For example, the steps illustrated in the example blocks shown in FIG. 8 may be performed to manufacture the ceramic pellets 120 of FIGS. 1-6, according to embodiments herein.

At block 802, a plurality of ceramic pellets is produced. For example, producing the plurality of ceramic pellets (e.g., the ceramic pellets 120) may include manufacturing the ceramic pellets that may operate as the infill material for the synthetic turf system. In embodiments, the ceramic pellets may be produced according to specifications that optimize their performance as infill, such as specific size ranges, densities, compositions, heat-regulation configuration, etc.

At block 804, the plurality of ceramic pellets is configured with one or more characteristics to facilitate application as an infill for a synthetic turf. For example, various properties of the ceramic pellets may be configured or set to configure their functionality within the synthetic turf system. For example, the ceramic pellets may be treated to modify their surface characteristics (e.g., roughness, reflectivity, etc.), coated to achieve particular color properties, infused with additional materials, etc.

In some embodiments, configuring the plurality of ceramic pellets with one or more characteristics to facilitate application as an infill for a synthetic turf may include sorting the ceramic pellets by size or density to create layered infill structures. Additionally, coatings or treatments may be applied to the ceramic pellets to control thermal properties, enhance durability, add specific functionalities such as insect repellence or odor neutralization, etc.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

Moreover, the description in this patent document should not be read as implying that any particular element, step, or function can be an essential or critical element that must be included in the claim scope. Also, none of the claims can be intended to invoke 35 U.S.C. § 112 (f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112 (f). Even under the broadest reasonable interpretation, in light of this paragraph of this specification, the claims are not intended to invoke 35 U.S.C. § 112 (f) absent the specific language described above.

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the disclosures can be established by the appended claims rather than by the foregoing description. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

What is claimed is:

1. A synthetic turf system, comprising:
a plurality of synthetic turf fibers; and
a plurality of ceramic pellets interspersed among the synthetic turf fibers, wherein each of the ceramic pellets of the plurality of ceramic pellets has a hardness on the Mohs scale within the range of 6 to 8, a density within the range of 0.5 to 2.15 g/cm³, and a sphericity and roundness rating within the range of 0.7 to 0.99.

2. The synthetic turf system of claim 1, wherein the ceramic pellets of the plurality of ceramic pellets include a mixture of alumina fines and at least one of kaolin or bauxite.

3. The synthetic turf system of claim 1, wherein the ceramic pellets of the plurality of ceramic pellets are chemically inert and free from respirable quartz silica dust.

4. The synthetic turf system of claim 1, wherein the ceramic pellets of the plurality of ceramic pellets include a ceramic pellet core and a coating.

5. The synthetic turf system of claim 4, wherein the coating includes a resin or polyurethane material.

6. The synthetic turf system of claim 4, wherein the coating is configured to control thermal properties of the ceramic pellets.

7. The synthetic turf system of claim 1, wherein the ceramic pellets of the plurality of ceramic pellets include a plurality of small ceramic pellets and a plurality of large ceramic pellets.

8. The synthetic turf system of claim 7, wherein ceramic pellets of the plurality of small ceramic pellets have the same density as ceramics of the plurality of large ceramic pellets, and wherein the plurality of large ceramic pellets is configured to remain near a surface of the synthetic turf system and the plurality of small ceramic pellets is configured to settle towards a bottom of the synthetic turf system.

9. The synthetic turf system of claim 1, wherein the ceramic pellets of the plurality of ceramic pellets are infused with at least one of an oxide for reducing microplastics, citronella for repelling insects, and a urine neutralizer.

10. The synthetic turf system of claim 1, wherein the ceramic pellets of the plurality of ceramic pellets are configured to maintain the synthetic turf system at temperatures approximately 15-20° F. lower than synthetic turf systems with crumb rubber infill under similar environmental conditions.

11. A method of installing a synthetic turf system, comprising:
obtaining a plurality of ceramic pellets;
configuring the plurality of ceramic pellets with one or more characteristics to facilitate application as an infill for synthetic turf; and
spreading the plurality of ceramic pellets over at least a portion of a synthetic turf surface.

12. The method of claim 11, wherein configuring the plurality of ceramic pellets includes adjusting a surface texture of the ceramic pellets to control heat absorption properties.

13. The method of claim 12, wherein adjusting the surface texture includes creating a glossy finish on at least a portion of the ceramic pellets to enhance sunlight reflection.

14. The method of claim 11, wherein configuring the plurality of ceramic pellets includes infusing the ceramic pellets with at least one of an oxide for reducing microplastics, citronella for repelling insects, or a urine neutralizer.

15. The method of claim 11, wherein spreading the plurality of ceramic pellets includes distributing a first layer of small ceramic pellets and a second layer of large ceramic pellets.

16. The method of claim 15, wherein ceramic pellets of the plurality of small ceramic pellets have the same density as ceramics of the plurality of large ceramic pellets, and wherein the plurality of large ceramic pellets is configured to remain near a surface of the synthetic turf system and the plurality of small ceramic pellets is configured to settle towards a bottom of the synthetic turf system.

17. A ceramic pellet for use as infill in a synthetic turf system, the ceramic pellet comprising:
a ceramic core; and
a coating applied to the ceramic core, wherein the ceramic pellet is configured to have thermal regulation properties to control a surface temperature of the synthetic turf system.

18. The ceramic pellet of claim 17, wherein the coating comprises a light-colored material configured to reflect sunlight and reduce heat absorption.

19. The ceramic pellet of claim 18, wherein the coating has a glossy finish to increase sunlight reflection.

20. The ceramic pellet of claim 19, wherein the ceramic core comprises a mixture of alumina fines and at least one of kaolin or bauxite, and wherein the ceramic pellet has a hardness on the Mohs scale within the range of 6 to 8, a density within the range of 0.5 to 2.15 g/cm³, and a sphericity and roundness rating within the range of 0.7 to 0.99.
